(19) United States
(12) Patent Application Publication
(10) Pub. No.: US 2009/0123621 A1
(43) Pub. Date: May 14, 2009

(54) Feed additive and a method for the production thereof

(75) Inventors: Natalya Ilyinichna Eisenshtadt, St. Petersburg (RU); Margarita Serafimovna Bosenko, St. Petersburg (RU); Aleksandr Dmitrievich Vilesov, St. Petersburg (RU); Marina Sergeevna Vilesova, St. Petersburg (RU); Roman Vladimirovich Stepanov, St. Petersburg (RU); Richard Petrovich Stankevich, St.Petersburg (RU); Olga Mikhailovna Suvorova, St. Petersburg (RU); Larisa Petrovna Chukova, St. Petersburg (RU); Elena Avgustovna Nechaeva, St. Petersburg (RU)

Correspondence Address: STEPTOE & JOHNSON LLP, 1330 CONNECTICUT AVENUE, N.W., WASHINGTON, DC, 20036, US

(73) Assignee: OOO DELSI, St. Petersburg (RU)

(21) Appl. No.: 12/096,399

(22) PCT Filed: Dec. 6, 2006
(86) PCT No.: PCT/IB06/03492

§ 371 Date: Jan. 5, 2009

Related U.S. Application Data
(60) Provisional application No. 60/777,009, filed on Feb. 27, 2006.

(30) Foreign Application Priority Data
Dec. 7, 2005 (RU) 2005138087

(51) Int. Cl. A23K 1/14

(52) U.S. Cl. 426/422; 426/655

(57) ABSTRACT

The method for producing the feed additive based on the processed conifer needle extracts, which is unique, because it uses the microgranulation of the neutralized conifer needle extract and a water-soluble polymer matrix/binding agent in the form of an aqueous solution, which is combined with the extract; this mixture is then added dropwise to an aqueous solution of a crosslinking agent, whereby sodium alginate or a protein/anionic polysaccharide complex, consisting of gelatin and sodium alginate, is used as the polymer matrix/binding agent, and water-soluble calcium salts are used as the crosslinking agent (the calcium salts ensure the obtainment of an insoluble matrix of microgranules), or a protein/anionic polysaccharide complex, consisting of gelatin and sodium alginate, is used as the polymer matrix/binding agent and water-soluble iron salts are used as the crosslinking agent (the iron salts ensure the obtainment of an insoluble matrix of microgranules).

The invention relates to the field of the production of feed additives and can be used as biologically active feed additives in food rations used in poultry farming, animal husbandry, fur farming, and fish farming.

A method is known for the production of products from needle-bearing conifer wood, for example, a natural conifer extract, chlorophyll-carotene paste, and conifer vitamin meal (Russian Patent No. RU 2041646, A23K1/00, Dec. 30, 1992). The method specifies a two-stage extraction of needle-bearing wood from the fir and pine. This increases the yield of extractable substances, while protecting the biologically active substances from disintegration, and permits the more effective utilization of the waste needle-bearing wood.

The obtained extracts can be used later in food rations for poultry, animals, and fur-bearing animals.

A method is known for the processing of coarse plant material, specifically needles, into highly nutritional feed with an increased protein content (Russian Patent No. RU 2088106, A23K1/12, Mar. 24, 1995). The substance of the method is as follows. The needle/twig material (NTM) is ground into particles, 5×(4-6) cm in size, and then processed in a disperser for 7-10 minutes and separated into phases; the solid phase of the NTM is inoculated with the fungal strain Pleurotus ostreatus (Fr) and the culturing proceeds for 16 days.

The conifer feed additive has a specific conifer odor and an unpleasant burning aftertaste, which must be masked so that animals can easily consume these substances. In addition, the metering in of the paste-like substances and their uniform distribution in dry feed is problematic in view of their viscous consistency.

To mask the odor and taste of conifer needle extracts and also for the convenience and uniformity of their metering in at low concentrations, these products were microencapsulated.

The microencapsulation of conifer needle extracts in a membrane, containing gelatin and a tanning agent, is known (Russian Patent No. RU 2021736, Jul. 15, 1993, A23K 1/00, 1/14); the ratio of ingredients is as follows, % by weight: conifer needle extract 75.0-92.0, gelatin 5.0-20.0, and tanning agent 0.5-5.0.

In this patent, the water-insoluble product, obtained by the extraction of conifer needles with use of organic solvents (benzene), after separation of waxes from the extracts and removal of the solvent and essential oils is used as the basic biologically active substance (BAS). Microencapsulation is done by the formation of membranes of water-soluble polymer-gelatin in an aqueous medium on the surface of particles (cores) of the conifer needle concentrate, first dispersed in the aqueous medium to sizes of 100-2000 μm. This is followed by the stages of tanning of the membrane, washing of the capsules, isolation of the microcapsules, and drying. The obtained microencapsulated preparation is stable in the acidic medium of gastric juice, but hydrolyzes readily in the alkaline medium of the intestine, where BAS are assimilated. This preparation is effective, as has been demonstrated in examples in which the quality of fur production in mink and the meat production in chickens were increased.

Despite the positive results obtained with the use of microencapsulation, the known method has a number of major limitations and drawbacks:

The technical process is expensive because of the multiple stages and the duration of the stages.

There is a large amount of wastewater, which requires disposal because it cannot be reused.

There is great variation in the basic physicochemical parameters of the raw material (due to seasonal variations, nature of the raw material, and growing area), necessitating constant adjustment of the technological process at the stages of emulsion production and creation of the microcapsule membranes.

The objective of this invention is to overcome the aforementioned drawbacks of the feed additive production process.

This objective is achieved as follows: The method for producing the feed additive is based on the processed conifer needle extracts and is different from the original method in that it uses the microgranulation of the neutralized conifer needle extract with a water-soluble polymer matrix/binding agent in the form of an aqueous solution, which is combined with the extract, and the obtained mixture is then added dropwise to an aqueous solution of a crosslinking agent, whereby sodium alginate or a protein/anionic polysaccharide complex, consisting of gelatin and sodium alginate, is used as the polymer matrix/binding agent, and water-soluble calcium salts are used as the crosslinking agent (the calcium salts ensure the obtainment of an insoluble matrix of microgranules), or a protein/anionic polysaccharide complex, consisting of gelatin and sodium alginate, is used as the polymer matrix/binding agent and water-soluble iron salts are used as the crosslinking agent (the iron salts ensure the obtainment of an insoluble matrix of microgranules).

The obtained dried granules contain the following components, % by weight (in terms of dry matter):

| | |
|---|---|
| Extracts from conifer needles | 70-90 |
| Polymer matrix/binding agent | 9-25 |
| Crosslinking agent (in terms of calcium ions Ca²⁺) | 0.04-0.10 |
| or | |
| Crosslinking agent (in terms of iron ions Fe³⁺) | 0.05-0.5. |

The polymer matrix/binding agent contains sodium alginate or sodium alginate with gelatin in a weight ratio of 4:1 to 3:2, with the following ratio of components, % by weight: sodium alginate 9-25; gelatin 0-10.

The polymer matrix/binding agent contains sodium alginate with gelatin, in a weight ratio of 4:1 to 3:2, with the following ratio of components, % by weight: sodium alginate 6-18; gelatin 2-12.

Examples of the calcium ion (Ca²⁺) source are water-soluble or partially water-soluble calcium salts and various inorganic acids, for example, calcium dichloride and calcium glycerophosphate, and also organic acids, such as aliphatic acids, for example, calcium acetate, hydroxy acids, for example, lactic and gluconic acids, and aromatic acids, for example, benzoic, salicylic, and acetyl-o-salicylic acids, in concentrations necessary to ensure a calcium ion (Ca²⁺) concentration within the range of 0.4-1.0% by weight in the bath with the crosslinking agent solution.

Water-soluble or partially water-soluble iron salts and inorganic acids, for example, hydrochloric and sulfuric acid, are used as the source of iron ions Fe³⁺. This includes mixed salts of the alum type in concentrations necessary to achieve an iron ion (Fe³⁺) concentration within the range of 0.5-5.0% by weight in the bath with the crosslinking agent solution.

Extracts obtained from needles of various conifer species with the use of various extracting agents can be used in the proposed method as conifer needle extracts. The obtained extracts are converted to the water-soluble form via neutralization with an aqueous sodium hydroxide solution to pH values =8-10, and they are thereby converted into aqueous pastes. The primary ingredients for the feed additive in these pastes are chlorophyll and chlorophyll derivatives, carotene and carotenoids, flavonoids, polyprenols, and also vitamins K, C, P, group B vitamins, and tocopherol (provitamin E).

Microgranulation of the neutralized conifer needle extract is performed using the water-soluble polymer matrix/binding agent, which is combined with the extract, and then the combined system, which represents a mixture of the neutralized conifer needle extract and the polymer matrix/binding agent in the form of an aqueous solution, is added dropwise to an aqueous solution of the crosslinking agent.

Two methods are possible for the production of the feed additive:

In the first method, either an aqueous solution of sodium alginate or a protein/anionic polysaccharide complex consisting of gelatin and sodium alginate (taken in a ratio by weight of 4:1 to 3:2), is used as the water-soluble polymer matrix/binding agent, and water-soluble calcium salts are used as the crosslinking agent. The latter assure the obtainment of an insoluble polymer matrix of microgranules due to the reaction between calcium ions Ca²⁺ with the carboxyl groups of sodium alginate.

We established that the reaction of calcium ions Ca²⁺ with the acid groups happens almost instantaneously, creating, on the surface of the microgranule, barriers that prevent the further deeper penetration of Ca²⁺ ions into the microgranule and the formation of a more densely crosslinked net-like structure. Gelatin plays the role of a regulator of microgranule disintegration in the gastrointestinal tract (GI tract) under the conditions of granule formation.

Used as the calcium ion (Ca²⁺) source are water-soluble or partially water-soluble calcium salts and various inorganic acids, such as calcium dichloride and calcium glycerophosphate, and also organic acids, such as aliphatic acids (for example, calcium acetate), hydroxy acids (for example, lactic and gluconic acids), and aromatic acids (for example, benzoic, salicylic, and acetyl-o-salicylic acids), in concentrations that ensure a calcium ion (Ca²⁺) concentration within the range of 0.4-1.0% by weight in the bath with the crosslinking agent solution. The calcium salt solutions can be used many times with correction of the calcium ion concentrations, which provides a virtually waste-free process.

In the second method, a protein/anionic polysaccharide complex consisting of gelatin and sodium alginate (taken in a ratio by weight of 4:1 to 3:2) is used as the water-soluble polymer matrix/binding agent, and water-soluble iron salts are used as the crosslinking agent. When iron salts are used as the crosslinking agent, the crosslinking of the polymer matrix occurs due to the reaction of iron ions with functional groups of gelatin.

In this case, the rate of the crosslinking by iron ions is slower than during crosslinking of the matrix by reacting sodium alginate with calcium ions; this makes it possible to regulate the extent of the crosslinking to control the final properties of the microgranules and the operations of the technological process.

From the physiological standpoint, microgranulation of the feed additive assures its effective preservation in a medium of gastric juice (at a pH˜1.5 in the presence of pepsin) for no more than 1 hour, so that the biologically active substances do not disintegrate, and, on the contrary, its complete destruction in the juice of the duodenum (at a pH˜7.5 in the presence of pancreatin) within no more than 3 hours (to assure the absorption of the additive through the intestinal wall).

The behavior of the microgranulated feed additive based on conifer needle extracts was tested at a temperature of 37° C. in a medium of gastric and intestinal juice. The data are presented in Table 1.

TABLE 1
Behavior of Microgranulated Feed Additive in a Medium of
Gastric and Intestinal Juice (in vitro)

| | |
|---|---|
| Exposure to | The granules remain whole for 1 hour. The surrounding |
| gastric juice | juice remains clear and colorless. The granules |
| | disintegrate completely within 50 minutes. |
| Exposure to | The surrounding juice begins to turn green from the very |
| intestinal juice | start of the exposure process. |

The proposed inventions are illustrated by examples.

Table 2 presents compositions, obtained with the use of various water-soluble calcium salts at various weight ratios between the conifer needle extract and the polymer matrix/binding agent, and also at different weight ratios between sodium alginate and gelatin in the binding agent, as well as formulations for the feed additives, reflecting the variation in both the content of components in microgranules and in the nature and content of the calcium salts, used for spatial crosslinking of the polymer matrix, which are in the precipitation bath.

TABLE 2

| | Content of Components, % by weight | | | | | | |
|---|---|---|---|---|---|---|---|
| Components | Example 1 | Example 2 | Example 3 | Example 4 | Example 5 | Example 6 | Example 7 |
| Conifer needle | 80 | 80 | 85 | 85 | 75 | 75 | 80 |
| extract (in terms of | | | | | | | |
| dry matter) | | | | | | | |
| Sodium alginate (dry | 16 | 12 | 9 | 12 | 15 | 25 | 16 |
| matter) | | | | | | | |
| Gelatin (dry matter) | 4 | 8 | 6 | 3 | 10 | 0 | 4 |
| Crosslinking agent | 0.07 | 0.04 | 0.10 | 0.07 | 0.05 | 0.07 | 0.06 |
| (in terms of the Ca²⁺ | | | | | | | |
| ion content) | | | | | | | |

Composition of the bath with calcium salts

| | Calcium Salt Content, % by weight/Ca²⁺ Ion Content, % by weight | | | | | | |
|---|---|---|---|---|---|---|---|
| Name of Salt | Example 1 | Example 2 | Example 3 | Example 4 | Example 5 | Example 6 | Example 7 |
| Calcium dichloride | 2.0/0.72 | | | | | | |
| CaCl₂ | | | | | | | |
| Calcium glycerol- | | 2.0/0.4 | | | | | |
| phosphate | | | | | | | |
| CaPO₃—O—C₃H₅(OH)₂ | | | | | | | |
| Calcium acetate | | | 4.0/1.0 | | | | |
| (CH₃COO)₂Ca | | | | | | | |
| Calcium benzoate | | | | 5.0/0.71 | | | |
| (C₆H₅COO)₂Ca | | | | | | | |
| Calcium gluconate | | | | | 5.0/0.46 | | |
| (CH₂OH—CHOH)₄—COO)₂Ca | | | | | | | |
| Calcium lactate | | | | | | 4.0/0.72 | |
| (CH₃CHOHCOO)₂Ca | | | | | | | |
| Calcium acetyl- | | | | | | | 6.0/0.6 |
| salicylate | | | | | | | |
| (CH³⁻O—CO—C₆H₄—COO)₂Ca | | | | | | | |

Note:
Any of the compositions for the calcium salt solutions presented in the table are suitable for forming microgranules with the compositions presented in Examples 1-7.

Table 3 presents the compositions, obtained with the use of various water-soluble iron salts at various weight ratios between the conifer needle extract and the polymer matrix/binding agent, and also at different weight ratios between sodium alginate and gelatin in the binding agent, as well as formulations for the feed additives, reflecting the variation in both the content of components in microgranules and in the nature and content of the iron salts, used for spatial crosslinking of the polymer matrix, which are in the precipitation bath.

TABLE 3

| | Content of Components, % by weight | | | |
|---|---|---|---|---|
| Components | Example 8 | Example 9 | Example 10 | Example 11 |
| Conifer needle | 85 | 85 | 80 | 80 |
| extract (in terms | | | | |
| of dry matter) | | | | |
| Sodium alginate | 9 | 9 | 12 | 12 |
| (dry matter) | | | | |
| Gelatin (dry matter) | 6 | 6 | 8 | |
| Crosslinking agent | 0.033 | 0.035 | 0.035 | 0.042 |
| in terms of | | | | |
| the Fe³⁺ | | | | |
| ion content) | | | | |

Composition of the bath with iron salts

| | Iron Salt Content, % by weight/Fe³⁺ Ion | | | |
|---|---|---|---|---|
| | Content, % by weight | | | |
| | | | Example | Example |
| Name | Example 8 | Example 9 | 10 | 11 |
| Iron-potassium | 3.0/0.33 | | | |
| sulfate (alum) | | | | |
| Fe₂(CO₄)₃•KSO₄•24H₂O | | | | |
| Iron sulfate, hydrate | | 1.8/0.35 | | |
| Fe₂(SO₄)₃•9H₂O | | | | |
| Iron chloride FeCl₃ | | | 1.0/0.35 | |
| Iron chloride, hydrate | | | | 2.0/0.42 |
| FeCl₃•6H₂O | | | | |

Note:
Any of the compositions for the iron salt solutions presented in the table are suitable for forming microgranules with the compositions presented in Examples 8-11.

### CONCLUSIONS

Microgranules, obtained by the claimed method in an in vitro experiments showed the protective effect—preservation of biologically active components—in gastric juice at the level of the microencapsulated products, whereas in the intestinal juice medium the microgranules disintegrate more rapidly, which promotes their physiological effectiveness.

The shortening of the production cycle in comparison with the known method (prior art) from a period of less than 1 day with any reactor volume to the short-run formation of microgranules, whose quantity is limited only by the number of filler units/granulators.

In contrast to the known method, the claimed method can be designed equipment-wise as a continuous process.

There is virtually no wastewater due to the repeated use of the solutions of crosslinking agents—calcium salts.

The proposed inventions will find use in the sectors of poultry farming, animal husbandry, fur farming, and fish farming in food rations as an effective feed additive.

1. The method for producing the feed additive based on the processed conifer needle extracts, which is unique, because it uses the microgranulation of the neutralized conifer needle extract and a water-soluble polymer matrix/binding agent in the form of an aqueous solution, which is combined with the extract; this mixture is then added dropwise to an aqueous solution of a crosslinking agent, whereby sodium alginate or a protein/anionic polysaccharide complex, consisting of gelatin and sodium alginate, is used as the polymer matrix/binding agent, and water-soluble calcium salts are used as the crosslinking agent (the calcium salts ensure the obtainment of an insoluble matrix of microgranules), or a protein/anionic polysaccharide complex, consisting of gelatin and sodium alginate, is used as the polymer matrix/binding agent and water-soluble iron salts are used as the crosslinking agent (the iron salts ensure the obtainment of an insoluble matrix of microgranules):

| | |
|---|---|
| Extracts from conifer needles | 70-90 |
| Polymer matrix/binding agent | 9-25 |
| Crosslinking agent (in terms of calcium ions Ca²⁺) | 0.04-0.10 |
| or | |
| Crosslinking agent (in terms of iron ions Fe³⁺) | 0.05-0.50. |

or

2. Feed additive obtained by the method according to claim 1, containing the biologically active substance—conifer needle extracts, characterized in that it contains the following components, % by weight (in terms of dry matter):

| | |
|---|---|
| Extracts from conifer needles | 70-90 |
| Polymer matrix/binding agent | 9-25 |
| Crosslinking agent (in terms of calcium ions Ca²⁺) | 0.04-0.10 |
| or | |
| Crosslinking agent (in terms of iron ions Fe³⁺) | 0.05-0.50. |

3. Feed additive according to claim 2 is unique, because the polymer matrix/binding agent contains sodium alginate or sodium alginate with gelatin, in a weight ratio of 4:1 to 3:2, with the following ratio of components, % by weight:

| | |
|---|---|
| Sodium alginate | 9-25 |
| Gelatin | 0-10, |

and water-soluble or partially water-soluble calcium salts as the crosslinking agent.

4. Feed additive according to claim 2 is unique, because the polymer matrix/binding agent contains sodium alginate with gelatin in a weight ratio of 4:1 to 3:2, with the following ratio of components, % by weight:

| Sodium alginate | 6-18 or |
|---|---|
| Gelatin | 2-12, |

and water-soluble or partially water-soluble iron salts as the crosslinking agent.

5. Feed additive according to claim 2 is unique, because for the calcium ion (Ca²⁺) source it uses water-soluble or partially water-soluble calcium salts and various inorganic acids—calcium dichloride, calcium glycerophosphate, and also organic acids, such as aliphatic acids, for example, calcium acetate, hydroxy acids, for example, lactic and gluconic acids, and aromatic acids, for example, benzoic, salicylic, and acetyl-o-salicylic acids, in concentrations necessary to ensure a calcium ion (Ca²⁺) concentration within the range of 0.4-1.0% by weight in the bath with the crosslinking agent solution.

6. Feed additive according to claim 2 is unique, because for the source of iron ions Fe³⁺ it uses water-soluble or partially water-soluble iron salts and inorganic acids, for example, hydrochloric and sulfuric acid, including mixed salts of the alum type, in concentrations necessary to achieve an iron ion (Fe³⁺) concentration within the range of 0.5-5.0% by weight in the bath with the crosslinking agent solution.
